(19) United States
(12) Patent Application Publication
(10) Pub. No.: US 2009/0295810 A1
(43) Pub. Date: Dec. 3, 2009

(54) INFORMATION PROCESSING APPARATUS

(75) Inventor: Masaya ENDO, Higashiyamato-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/474,090

(22) Filed: May 28, 2009

(30) Foreign Application Priority Data
May 28, 2008 (JP) 2008-139547

(51) Int. Cl. G06F 15/16

(52) U.S. Cl. 345/502

(57) ABSTRACT

According to one embodiment, an information processing apparatus includes a display module, a first display controller configured to generate a first video signal, a second display controller configured to generate a second video signal, a selection module configured to select one of the first and second video signals, and output the selected video signal to the display module.

### CROSS-REFERENCE TO RELATED APPLICATIONS

This application is based upon and claims the benefit of priority from Japanese Patent Application No. 2008-139547, filed May 28, 2008, the entire contents of which are incorporated herein by reference.

### BACKGROUND

1. Field

One embodiment of the present invention relates to a technique of controlling a plurality of GPUs (Graphics Processing Units), and more particularly, an information processing apparatus capable of readily switching the display of video outputs from GPUs.

2. Description of the Related Art

When a high throughput is required for a computer, a computer which includes a plurality of processors and a control module for controlling these processors is generally used. For example, a computer which includes two processors having different throughputs uses a processor having a high throughput when high system performance is required. In this case, the power consumption is higher than that when using a processor having a low throughput. On the other hand, in the case of, e.g., a battery-driven notebook personal computer, the battery life may have priority over the system performance. In this case, the power consumption can be suppressed by switching from a processor having a high throughput to that having a low throughput, thereby prolonging the battery life. To the contrary, when a battery-driven notebook personal computer can be supplied with power from an AC power supply, it is possible to increase the overall throughput by switching from a processor having a low throughput to that having a high throughput. For example, Jpn. Pat. Appln. KOKAI Publication No. 2003-316751 discloses the following technique of controlling a plurality of processors. That is, in a system including two CPUs having different throughputs, the operating ratio of the system is monitored at all times. If it is determined that the operating ratio of the system is low when a CPU having a high throughput is operating, the CPU having a high throughput is switched to that having a low throughput in order to suppress the power consumption.

On the other hand, in the case of controlling a plurality of GPUs having different throughputs, when a GPU is switched to another, disturbance, noise, or the like can occur in an image displayed on a display due to the difference in operation clock frequency.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an information processing apparatus according to an embodiment of the present invention;

FIG. 2 is an exemplary block diagram showing the main components of the information processing apparatus according to the embodiment;

FIG. 3 is an exemplary block diagram showing the functional arrangement of a BIOS of the information processing apparatus according to the embodiment;

FIG. 4 is an exemplary flowchart showing a display controller switching method to which the information processing apparatus according to the embodiment is applied;

FIG. 5 is an exemplary flowchart showing a display controller switching method to which the information processing apparatus according to the embodiment is applied; and

FIG. 6 is an exemplary timing chart schematically showing the timings of GPU switching processing to illustrate the display controller switching method to which the information processing apparatus according to the embodiment is applied.

### DETAILED DESCRIPTION

Various embodiments according to the invention will be described hereinafter with reference to the accompanying drawings. In general, according to one embodiment of the invention, an information processing apparatus includes: a display module; a first display controller configured to generate a first video signal; a second display controller configured to generate a second video signal; a selection module configured to select one of the first and second video signals, and output the selected video signal to the display module; and a control module configured to make, when switching a display controller to be used to supply a video signal to the display module from the first display controller to the second display controller, transition of a state of the second display controller from an inoperative state to an operative state and set the display module to a display-off state in which a screen image is not displayed, and reset, after a video signal to be output to the display module is switched from the first video signal to the second video signal by controlling the selection module, the display module to a display-on state in which a screen image is displayed and make transition of a state of the first display controller from an operative state to an inoperative state.

An embodiment of the present invention will be described below with reference to the accompanying drawings.

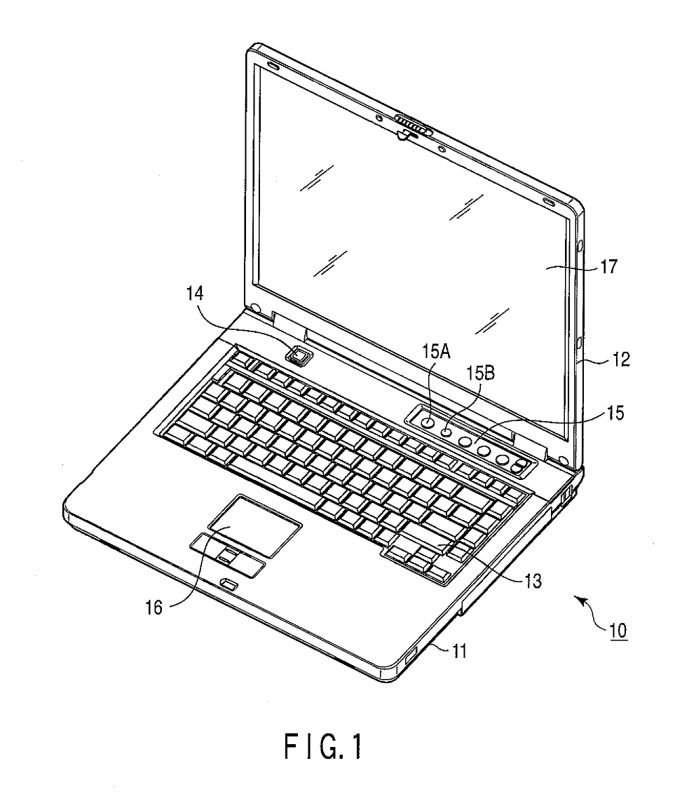

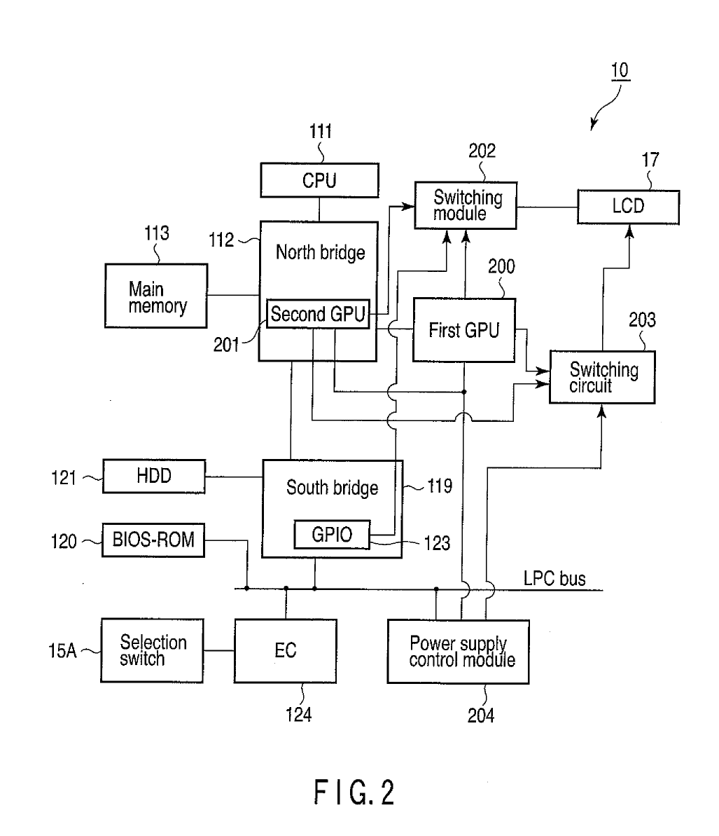

First, the arrangement of an information processing apparatus according to the embodiment of the present invention will be explained with reference to FIGS. 1 and 2. The information processing apparatus is implemented as, e.g., a notebook personal computer 10.

FIG. 1 is a perspective view showing a state in which the display unit of the notebook personal computer 10 is open. The computer 10 includes a computer main body 11 and a display unit 12. The display unit 12 has a built-in display device formed from an LCD (Liquid Crystal Display: display module) 17. The display screen of the LCD 17 is located almost at the center of the display unit 12.

The display unit 12 is attached to the computer main body 11 to freely pivot between the open position and the close position. The computer main body 11 has a thin box-shaped housing and includes, on its upper surface, a keyboard 13, a power button 14 to power on/off the computer 10, an input operation panel 15, and a touch pad 16.

The input operation panel 15 is an input device that inputs an event corresponding to a pressed button to a system. The input operation panel 15 has a plurality of buttons to activate a plurality of functions. The buttons include a selection switch 15A which triggers GPU (Graphics Processing Unit: to also be referred to as a graphics controller hereinafter) switching, and a DVD (Digital Versatile Disc) activation button 15B.

The system configuration of the computer 10 will be described next with reference to FIG. 2.

As shown in FIG. 2, the computer 10 includes a CPU 111, the first GPU (the first display controller) 200, a north bridge 112 equipped with the second GPU (the second display controller) 201, a main memory 113, a switching module (selection module) 202, the LCD (display module) 17, a switching circuit 203, a south bridge 119, a hard disk drive (HDD) 121, the selection switch 15A, an EC (embedded controller IC) 124, a network controller 125, a BIOS (Basic Input Output System)-ROM (control module) 120, and a power supply control module 204.

The CPU 111 is a processor for controlling the operation of the computer 10 and executes an operating system (OS) and various application programs, which are loaded from the hard disk drive (HDD) 121 to the main memory 113.

The CPU 111 also executes a system BIOS stored in the BIOS-ROM 120. The system BIOS is a program for hardware control.

The north bridge 112 is a bridge device for connecting the local bus of the CPU 111 to the south bridge 119. The north bridge 112 incorporates a memory controller to control access to the main memory 113 and the GPU 201. The north bridge 112 also has a function of executing communication with the GPU 200 via a PCI Express bus or the like. The switching module 202 switches between video signals output from the GPUs 200 and 201 to the LCD 17. That is, in a state in which the first video signal output from the GPU 200 is displayed on the LCD 17, the switching module 202 executes processing of switching a video signal to be output to the LCD 17 to the second video signal output from the GPU 201. The switching circuit 203 is a circuit to power on/off the LCD 17 by the GPU 200 or 201.

The GPU 200 is a graphics controller which has high processing performance and consumes more power compared with the GPU 201. If an AC adaptor or the like is connected and processing performance is important, the GPU 200 is used. If the computer is driven by a battery or high processing performance is not required, the computer switches to the GPU 201 and uses it.

The GPU 201 is a graphics controller built into the north bridge 112, which has low processing performance and consumes power less than the GPU 200. If the computer is driven by a battery or high processing performance is not required, the GPU 201 is used.

The south bridge 119 controls devices on an LPC (Low Pin Count) bus and devices on a PCI (Peripheral Component Interconnect) bus. The south bridge 119 incorporates an IDE (Integrated Drive Electronics) controller to control the HDD 121 and the like. The south bridge 119 also has a function of controlling access to the BIOS-ROM 120 and the like. The south bridge 119 has a GPIO (General Purpose Input/Output) 123. The GPIO 123 is a general purpose input/output port and each port includes a data direction register (DDR) for controlling input/output and a data output register (DOR) for storing output data. When the DOR is read, the input state of a port specified as an input port or the output state of a port specified as an output port is read out. The DOR is a write-only register and its setting values are reflected in the port specified as an output port by the data input register (DIR). In this way, by reflecting the output of the port specified by the DIR of the GPIO 123 in the video signal output of the switching module 202, switching between the first and second video signals is performed.

The HDD 121 is a storage device for storing various kinds of software and data.

The EC 124 is a one-chip microcomputer on which an embedded controller for power management and the like are integrated. The EC 124 has a function of powering on/off the computer 10 as the user operates the power button 14.

The power supply control module 204 is a power supply controller IC for controlling power supply to the GPUs 200 and 201. This power supply controller IC is generally an IC connected to the south bridge 119 via the LPC bus. If the graphics controller currently used is the GPU 201, the BIOS-ROM 120 turns off the power supply circuit of the GPU 200 via the power supply control module 204. On the other hand, if the graphics controller currently used is the GPU 200, the BIOS-ROM 120 turns off a circuit for the output operation of the video signal of the GPU 201 (power is supplied to the north bridge 112).

The BIOS-ROM 120 switches the graphic controller to be used to the GPU 200 or 201 as the user operates the selection switch 15A. The BIOS-ROM 120 controls power supply to the GPUs 200 and 201 via the above power supply control module 204. The BIOS-ROM 120 switches the video signal output of the switching module 202 from the GPU 200 to the GPU 201 (or from the GPU 201 to the GPU 200) via the above GPIO 123. That is, the BIOS-ROM 120 reads out the output state of the switching module 202 by reading the DIR of the GPIO 123, and switches the video signal output of the switching module 202.

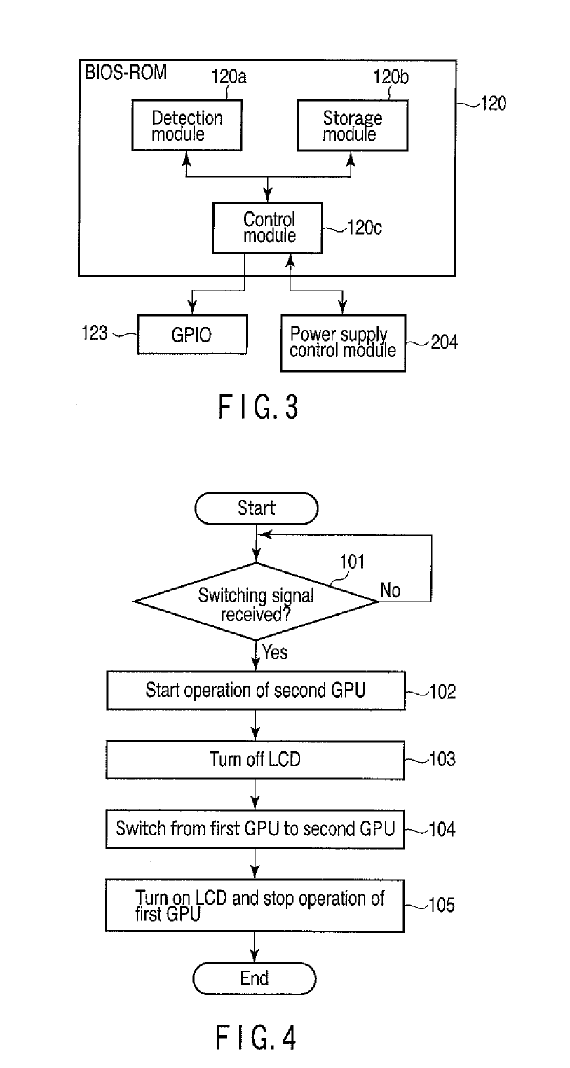

As shown in FIG. 3, the BIOS-ROM 120 includes a detection module 120a, a storage module 120b, and a control module 120c. When the user presses the selection switch 15A, a switching request signal is sent to the EC 124. Upon reception of the switching request signal via the EC 124, the detection module 120a starts switching processing. The storage module 120b stores information such as that representing whether the graphics controller currently used is the GPU 200 or 201. When switching, e.g., from the GPU 200 to the GPU 201, the control module 120c stops supplying power to the LCD 17 after activating the GPU 201, and sends to the switching module 202 a request for switching a video signal to be output to the LCD 17 to the second video signal. After the switching module 202 switches the video signal output, the control module 120c restarts power supply to the LCD 17, and executes processing of stopping the GPU 200. Along with the GPU switching processing, the control module 120c controls power supply to the GPUs 200 and 201 via the power supply control module 204. That is, the control module 120c turns on/off power supply to the GPUs 200 and 201. When turning off power supply to the GPU 201, the control module 120c turns off the circuit for the output operation of the video signal of the GPU 201 without stopping power supply to the north bridge 112. When powering off the LCD 17, the control module 120c may set the LCD 17 to a display-off state in which a screen image is not displayed. The display-off state includes a state in which only the backlight is OFF as well as a state in which the LCD 17 is in a power-off state.

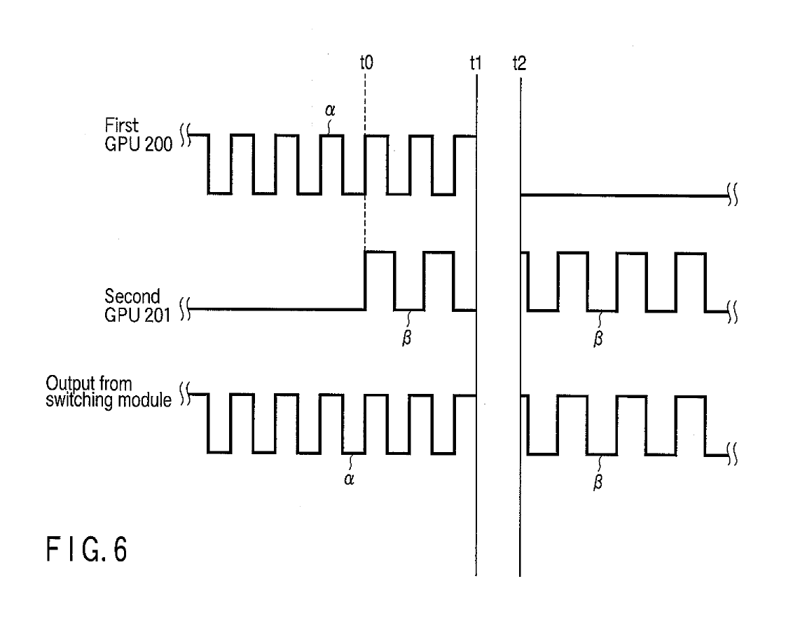

A display controller switching method to which the information processing apparatus having the above-described arrangement according to the embodiment of the present invention is applied will be explained next with reference to flowcharts in FIGS. 4 and 5, and FIG. 6. Note that FIG. 6 is a timing chart schematically showing the waveforms of the clock frequencies of the signals output from the GPUs 200 and 201 and switching module 202. Referring to FIG. 6, a period of time (t1 to t2) during which the LCD 17 is in a power-off state is superimposed on the waveforms (the GPUs 200 and 201 output signals at different clock frequencies).

FIG. 4 is a flowchart showing processing of switching from the GPU 200 to the GPU 201. In this state, since the graphics controller used is the GPU 200, the circuit for the output operation of the video signal of the GPU 201 is OFF. The GPU 200 (the switching module 202) outputs the video signal at a clock frequency α to the LCD 17 via the switching module 202, as shown in FIG. 6.

Upon receiving, via the EC 124, the switching request signal sent by pressing the selection switch 15A (YES in block 101: at a time t0 in FIG. 6), the BIOS-ROM 120 starts power supply to the circuit for the output operation of the video signal of the GPU 201 via the power supply control module 204 (block 102). The GPU 201 starts outputting a video signal at a clock frequency β to the switching module 202.

Subsequently, the BIOS-ROM 120 controls, via the switching circuit 203, the GPU 200 as the graphics controller currently used to turn off power supply from the power supply control module 204 to the LCD 17 (block 103: at a time t1 in FIG. 6). The BIOS-ROM 120 switches the video signal output of the switching module 202 from the GPU 200 to the GPU 201 via the GPIO (block 104). The BIOS-ROM 120 also stops the video signal output of the GPU 200 (the output at the clock frequency α of the GPU 200 in FIG. 6). The BIOS-ROM 120 then controls, via the switching circuit 203, the GPU 201 to power on the LCD 17 (at a time t2 in FIG. 6). At the same time, the BIOS-ROM 120 stops power supply to the whole circuit of the GPU 200 via the power supply control module 204 to stop the operation of the GPU 200 (block 105). In this state, the clock frequency of the video signal output from the switching module 202 to the LCD 17 is switched to β. Note that during the period from the time t1 to the time t2, since the LCD 17 is not powered, display on the LCD 17 is not performed and therefore disturbance of an image or the like due to the GPU switching is not displayed.

The processing of switching from the GPU 200 to the GPU 201 ends.

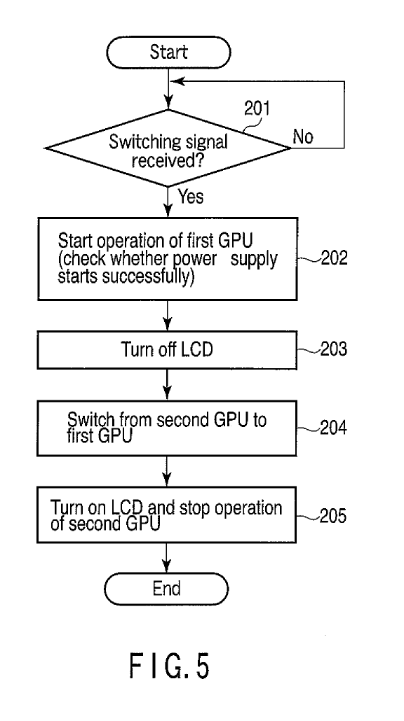

FIG. 5 is a flowchart showing processing of switching from the GPU 201 to the GPU 200. In this state, since the graphics controller used is the GPU 201, the power supply circuit of the GPU 200 is OFF. The video signal of the GPU 201 (the switching module 202) is output to the LCD 17 via the switching module 202.

Upon receiving, via the EC 124, the switching request signal sent by pressing the selection switch 15A (YES in block 201), the BIOS-ROM 120 starts power supply to the power supply circuit of the GPU 200 via the power supply control module 204 (block 202). At this time, the BIOS-ROM 120 checks if power supply to the power supply circuit of the GPU 200 has started. If power supply has not started, the BIOS-ROM 120 supplies power to the power supply circuit of the GPU 200 via the power supply control module 204 until the power supply starts.

Subsequently, the GPU 201 as the graphics controller currently used powers off the LCD 17 via the switching circuit 203 (block 203). The BIOS-ROM 120 switches the video signal output of the switching module 202 from the GPU 201 to the GPU 200 via the GPIO (block 204). At the same time, the BIOS-ROM 120 stops the video signal output from the GPU 201. The BIOS-ROM 120 controls, via the switching circuit 203, the GPU 200 to power on the LCD 17. Along with this, the BIOS-ROM 120 stops power supply to the circuit for the output operation of the video signal of the GPU 201 via the power supply control module 204 to stop the operation of the GPU 201 (block 205). Note that power is supplied to the north bridge 112.

The processing of switching from the GPU 201 to the GPU 200 ends.

As described above, in the GPU switching processing, since the frequency of operation clocks for each GPU is different from the other, a sync signal is offset at the time of switching between the video outputs of the GPUs. This causes disturbance or noise of an image, in switching the GPU, on the display to which the video signal is output. By powering off the LCD 17 during the switching processing, however, disturbance or noise of the image is not displayed on the LCD 17.

As shown in FIG. 6, for example, the above GPU switching period is a period from the time t1 to the time t2. The time t1 indicates a switching start time, while the time t2 indicates a switching end time. At the time t1, the switching processing starts and the processing of switching from a state in which a video signal is output based on the clock frequency a of the GPU 200 to a state in which a video signal is output based on the clock frequency β of the GPU 201 is executed. Although noise or the like occurs on the LCD 17 at the time of switching the GPUs, disturbance or noise of an image is not displayed by powering off the LCD 17 during the switching period (t1 to t2). At the time t2, the switching processing ends. In a state in which noise or the like is suppressed, it is possible to output a video signal on the basis of the clock frequency β of the GPU 201 after the switching by powering on the LCD 17.

As described above, according to the embodiment, even if the display switching of the video outputs of a plurality of GPUs is performed, it is possible to smoothly switch the GPUs without displaying disturbance or noise of an image on a display device by powering off the display device at the time of switching the GPUs. By not allowing noise or the like to be displayed on the display device, it is possible to reduce the load on the display device in switching the GPUs and improve the reliability.

It is an object of the present invention to provide an information processing apparatus capable of smoothly switching between a plurality of GPUs without causing noise or the like in an image displayed on a display.

To solve the above problem, according to an aspect of the present invention, there is provided (claim 1).

In the above embodiment, the EC 124 switches the graphics controller to be used as the user operates the selection switch 15A. The trigger of the graphics controller switching is, however, not limited to this. For example, the graphics controller to be used may be automatically switched upon detection of a state such as that in which the remaining amount of the battery of the computer 10 is changed, that in which the AC adaptor is connected, or that in which the processing performance required for the GPU is changed. That is, when the GPU 200 is used, if the remaining amount of the battery changes, the GPU used is switched to the GPU 201 which consumes less power. When the GPU 201 is used, if the AC adaptor is connected, the GPU used is switched to the GPU 200 having a high throughput. When the GPU 201 is used, if the processing performance required for the GPU is changed or a request for playing back a moving image or the like is issued, the GPU used may be switched to the GPU 200 having a high throughput.

Note that the present invention is not exactly limited to the above embodiments, and constituent elements can be modified upon practice without departing from the spirit and scope of the invention. and a module can be accomplished in software and hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display;
a first display controller configured to generate a first video signal;
a second display controller configured to generate a second video signal;
a selection module configured to select either the first or second video signal, and to output the selected video signal to the display; and
a display switching controller configured to change a state of the second display controller from an inoperative state to an operative state and to set the display to a display-off state in which a screen image is not displayed, and configured to set the display to a display-on state in which a screen image is displayed and to change a state of the first display controller from an operative state to an inoperative state after a video signal transmitted to the display is switched from the first video signal to the second video signal by controlling the selection module, when switching a display controller from the first display controller to the second display controller.

2. The apparatus of claim 1, wherein rendering processing performance of the first display controller is different from rendering process performance of the second display controller and power consumption of the first display controller is different from power consumption of the second display controller, respectively.

3. The apparatus of claim 2, wherein a clock frequency of the first display controller is different from a clock frequency of the second display controller.

4. The apparatus of claim 3, wherein at least one of the first and second display controllers is built into a chip set.

5. The apparatus of claim 1, wherein the display-off state comprises a state in which power supply to the display is turned off.

6. The apparatus of claim 1, wherein the display switching controller is configured to set the display to the display-off state after confirming that the second display controller has been set to a state where outputting of the second video signal is enabled.
